(19) United States
(12) Patent Application Publication
(10) Pub. No.: US 2017/0126159 A1
(43) Pub. Date: May 4, 2017

(54) GENERATION SYSTEM WITH BRAKING MECHANISM

(71) Applicant: Hamilton Sundstrand Corporation, Windsor Locks, CT (US)

(72) Inventors: Todd A. Spierling, Rockford, IL (US); Glenn C. Lemmers, JR., Loves Park, IL (US)

(21) Appl. No.: 14/926,708

(22) Filed: Oct. 29, 2015

(51) Int. Cl. H02P 9/06; F16H 1/28; H02K 7/18; H02K 7/102; H02K 7/116

(52) U.S. Cl. CPC H02P 9/06; H02K 7/102; H02K 7/116; H02K 7/1823; F16H 1/28

(57) ABSTRACT

An electrical power generation system for a vehicle includes a prime mover, an electrical generator to generate electrical power and a gear box operably connected to the prime mover and the electrical generator to transfer rotational energy from the prime mover to the electrical generator. A braking mechanism is located at the gear box to selectably transfer rotational energy from the prime mover to the electrical generator for selective generation of electrical power. A method of electrical power generation for a vehicle includes generating rotational energy at a prime mover, transferring the rotational energy to an electrical power generator, generating electrical power via the rotational energy transfer to the electrical power generator, and periodically stopping and/or starting the transfer of rotational energy from the prime mover to the electrical power generator via a braking mechanism in operable communication with the electrical power generator.

### BACKGROUND

The subject matter disclosed herein relates to aircraft. More specifically, the present disclosure relates to electrical power generation for aircraft.

Electrical power generators are utilized in many applications, such as aircraft or other vehicles to provide electrical power to various systems of the vehicle. In a typical aircraft application, the electrical generator is coupled to an aircraft engine and generates electrical power as the engine operates, to provide the system electrical power. The generator is coupled to the engine, such that whenever the engine is operating, the generator also operates and generates electrical power.

Some new aircraft applications, however, require large amounts of electrical power for a relatively small portion of flight time of the aircraft. The generator must, however, be sized for this peak electrical power usage, which in some aircraft may be about 1 megawatt, versus a typical electrical generator providing 0.1 megawatts. Allowing the larger generator to operate at all times the engine is operating would result in excess losses over the duration of the flight. It is desired to reduce the system losses of the power generation system when the electrical generator is not required.

### BRIEF SUMMARY

In one embodiment, an electrical power generation system for a vehicle includes a prime mover, an electrical generator to generate electrical power and a gear box operably connected to the prime mover and the electrical generator to transfer rotational energy from the prime mover to the electrical generator. A braking mechanism is located at the gear box to selectably transfer rotational energy from the prime mover to the electrical generator for selective generation of electrical power.

Additionally or alternatively, in this or other embodiments the gear box includes a planetary gear arrangement.

Additionally or alternatively, in this or other embodiments the planetary gear arrangement includes a sun gear coupled to the generator, a plurality of planet gears meshed with the sun gear and configured to traverse about a sun gear axis and a ring gear meshed with and disposed radially outboard of the plurality of planet gears. The prime mover is coupled to one of the plurality of planet gears or the ring gear, and the braking mechanism is located at the other of the plurality of planet gears or the ring gear to stop rotation of the ring gear or traversal of the plurality of planet gears.

Additionally or alternatively, in this or other embodiments a planet carrier couples the prime mover to the plurality of planet gears.

Additionally or alternatively, in this or other embodiments the planetary gear arrangement includes a sun gear coupled to the prime mover, a plurality of planet gears meshed with the sun gear and configured to traverse about a sun gear axis, and a ring gear meshed with and disposed radially outboard of the plurality of planet gears. The generator is coupled to one of the plurality of planet gears or the ring gear, and the braking mechanism is positioned at the other of the plurality of planet gears or the ring gear to stop rotation of the ring gear or traversal of the plurality of planet gears.

Additionally or alternatively, in this or other embodiments the planetary gear arrangement includes a sun gear coupled to the braking mechanism, a plurality of planet gears meshed with the sun gear and configured to traverse about a sun gear axis, the plurality of planet gears coupled to one of the generator or the prime mover, a ring gear meshed with and located radially outboard of the plurality of planet gears, the ring gear coupled to the other of the generator or the prime mover. The braking mechanism is configured to stop rotation of the sun gear.

Additionally or alternatively, in this or other embodiments the braking mechanism includes a locking mechanism to maintain engagement of the braking mechanism.

Additionally or alternatively, in this or other embodiments the prime mover is a gas turbine.

Additionally or alternatively, in this or other embodiments the vehicle is an aircraft.

In another embodiment, a method of electrical power generation for a vehicle includes generating rotational energy at a prime mover, transferring the rotational energy to an electrical power generator, generating electrical power via the rotational energy transfer to the electrical power generator, and periodically stopping and/or starting the transfer of rotational energy from the prime mover to the electrical power generator via a braking mechanism in operable communication with the electrical power generator.

Additionally or alternatively, in this or other embodiments the rotational energy is transferred from the prime mover to the electrical power generator through a planetary gear arrangement.

Additionally or alternatively, in this or other embodiments the rotational energy is transferred from the prime mover to a plurality of planet gears, the rotational energy is transferred from the plurality of planet gears to a sun gear meshed with the plurality of planet gears, and the rotational energy is transferred from the sun gear to the electrical power generator.

Additionally or alternatively, in this or other embodiments the rotational energy is transferred from the plurality of planet gears to the sun gear by stopping rotation of a ring gear meshed with the plurality of planet gears via engagement of a braking mechanism at the ring gear.

Additionally or alternatively, in this or other embodiments the transfer of rotational energy is selectably stopped from the plurality of planet gears to the sun gear by disengagement of the braking mechanism.

Additionally or alternatively, in this or other embodiments the braking mechanism includes a locking mechanism to maintain engagement of the braking mechanism.

Additionally or alternatively, in this or other embodiments the prime mover is a gas turbine.

Additionally or alternatively, in this or other embodiments the vehicle is an aircraft.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic view of an embodiment of a power generation system;

FIG. 2 is a schematic view of an embodiment of a planetary gear arrangement for a power generation system;

FIG. 3 is a schematic view of an embodiment of a power generation system in a clutched mode of operation;

FIG. 4 is a schematic view of another embodiment of a power generation system;

FIG. 5 is a schematic view of yet another embodiment of a power generation system;

FIG. 6 is a schematic view of still another embodiment of a power generation system;

FIG. 7 is a schematic view of a further embodiment of a power generation system; and

FIG. 8 is a schematic view of another embodiment of a power generation system.

### DETAILED DESCRIPTION

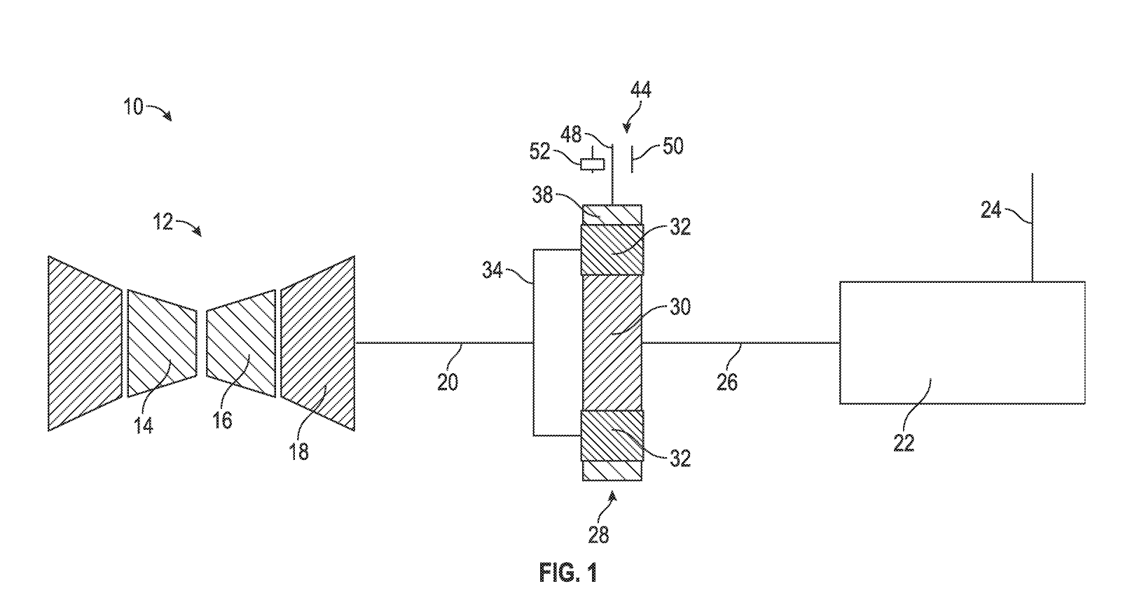

Shown in FIG. 1 is an embodiment of an electrical power generation system 10. The electrical power generation system 10 includes a prime mover, for example, an engine 12 such as a gas turbine engine for an aircraft or other vehicle. The gas turbine engine 12 generally includes a compressor 14 for pressurizing the air received into the engine 12 and a combustor 16 wherein the compressed air is mixed with fuel and ignited for generating combustion gases. The engine 12 further includes a turbine section 18 for extracting energy from the combustion gases and drive an output shaft 20.

The engine 12 is operably connected to a generator 22, which converts rotational energy received at the generator 22 into electrical power that may be transmitted by one or more output wires 24 to be utilized by systems of the aircraft, such as aircraft control systems, environmental control systems, weapons systems, and the like. The output shaft 20 is connected to the generator 22 by a generator shaft 26 through a gearbox 28.

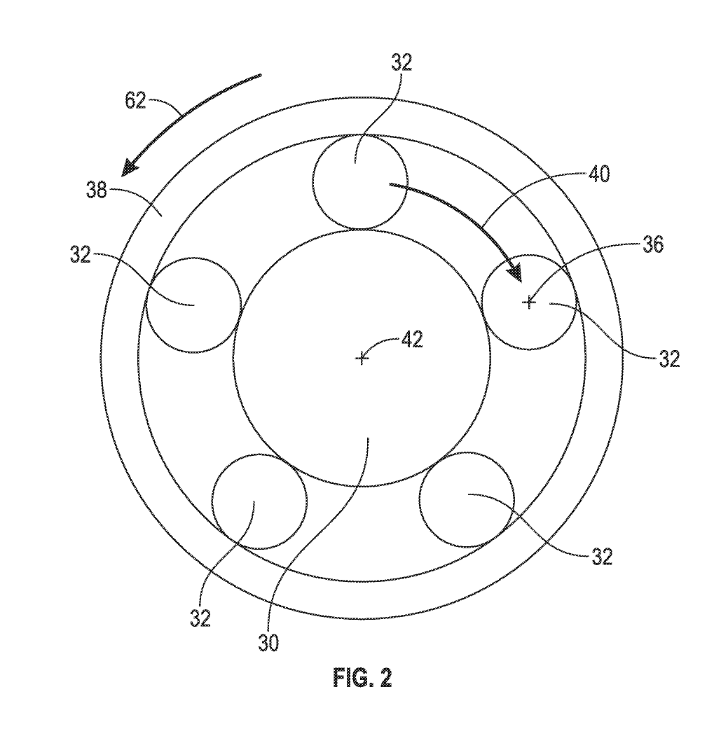

The gear box 28 is a planetary gear arrangement. The generator shaft 26 is connected to a sun gear 30, and the output shaft 20 is connected to a plurality of planet gears 32 arranged around and meshed with the sun gear 30. A planet gear carrier 34, connects the planet gears 32 to the output shaft 20 to transfer the rotational energy of the output shaft 20 to the planet gears 32 to drive orbit of the planet gears 32 around the sun gear 30, while allowing the planet gears 32 to rotate about their respective planet gear axes 36. Referring to FIG. 2, in some embodiments the plurality of planet gears 32 may include five planet gears 32, but in other embodiments other numbers of planet gears 32 may be utilized. A ring gear 38 surrounds the plurality of planet gears 32 and is meshed with the planet gears 32. The gear box 28 is configured to transfer rotational energy from the output shaft 20. In normal operation, the ring gear 38 is not rotationally fixed, allowing the rotational energy from the output shaft 20 to drive the orbit of the plurality of planet gears 32 in a first direction 40 about a gear axis 42 located at a center of the sun gear 30. The orbit of the planet gears 32 in the first direction 40 drives rotation of the ring gear 38 in a second direction 62 opposite the first direction 40. The normal operation of the gear box 28 does not drive rotation of the sun gear 30 to drive the generator 22 and generate electrical power.

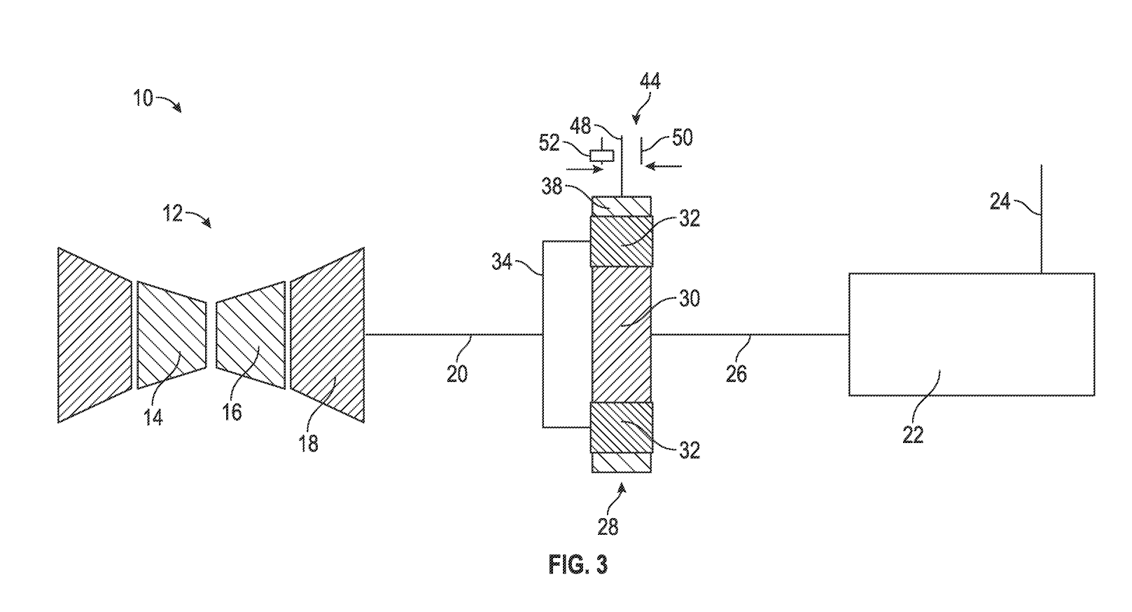

To drive rotation of the sun gear 30 and generation of electrical power by the generator 22, the ring gear 38 is selectably rotationally fixed. In some embodiments, referring again to FIG. 1, the gear box 28 includes a clutching mechanism, for example, a braking mechanism 44. The braking mechanism 44 is connected to a control system (not shown) that signals the braking mechanism 44 to stop rotation of the ring gear 38 when desired. Referring to FIG. 3, stoppage of rotation of the ring gear 38 results in rotation of the planet gears 32 in the first direction 40 driving rotation of the sun gear 30 in the second direction 62. Rotation of the sun gear 30 in the second direction 62 drives rotation of the generator shaft 26 and thus generation of electrical power at the generator 22.

The braking mechanism 44 includes a braking disc 48 fixed to the ring gear 38 and one or more brake calipers 50 engageable with the braking disc 48 to slow or stop rotation of the braking disc 48, and thus slow or stop rotation of the ring gear 38. In some embodiments, the braking disc 48 is a separate component secured to the ring gear 38, while in other embodiments the braking disc 48 may be an integral portion of the ring gear 38, for example, a flange of the ring gear 38. In some embodiments, the braking mechanism 44 includes a detent 52, which locks the position of the ring gear 38 once the rotation of the ring gear 38 is stopped, so that the friction between the braking disc 48 and the brake calipers 50 is not required to carry the subsequent torque. When operation of the generator 22 is not desired, the braking mechanism 44 is disengaged, allowing the ring gear 38 to rotate and stop transmission of rotational energy through the sun gear 30 to the generator 22. While a braking disc 48 and brake calipers 44 are shown in the figure and described herein, it is to be appreciated that other types of braking mechanisms may be utilized, such as a cone brake, band brake or drum brake.

The braking mechanism 44 allows for intermittent, as needed, operation of the generator 22. Further, the braking mechanism 44 is not directly part of the power train, but does carry torque during operation of the generator 22.

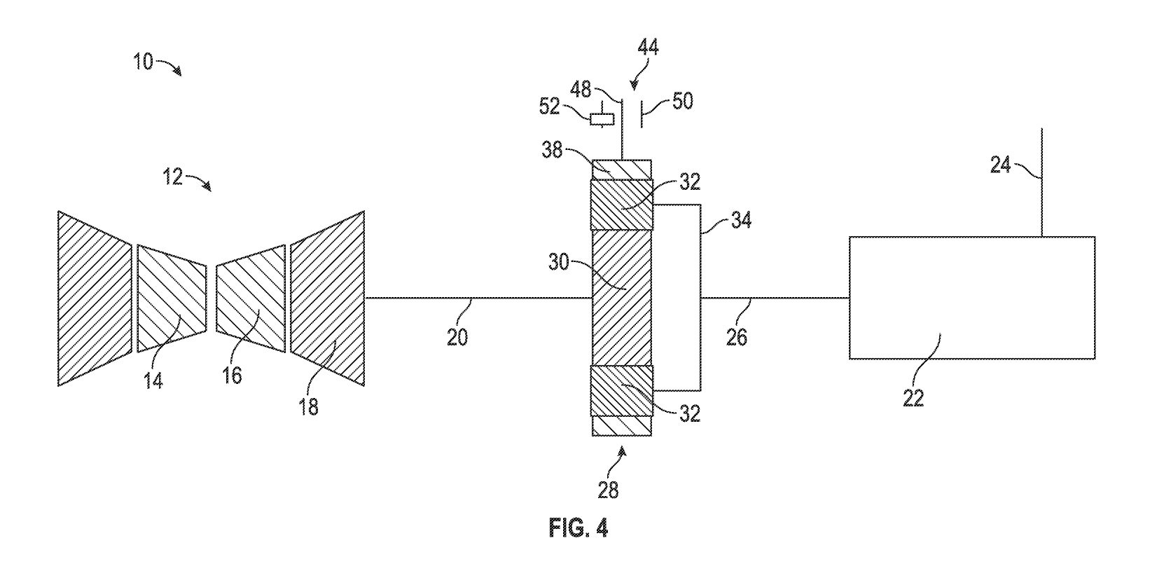

It is to be appreciated, however, that the embodiment of FIG. 3 is merely an example, with additional embodiments illustrated in FIGS. 4-8, which may be utilized depending on operational requirements, such as specific required generator 22 speeds and/or engine 12 speed. In the embodiment of FIG. 4, the generator shaft 26 is connected to the planet gear carrier 34, and the output shaft 20 is connected to the sun gear 30, while the braking mechanism 44 is located at the ring gear 38.

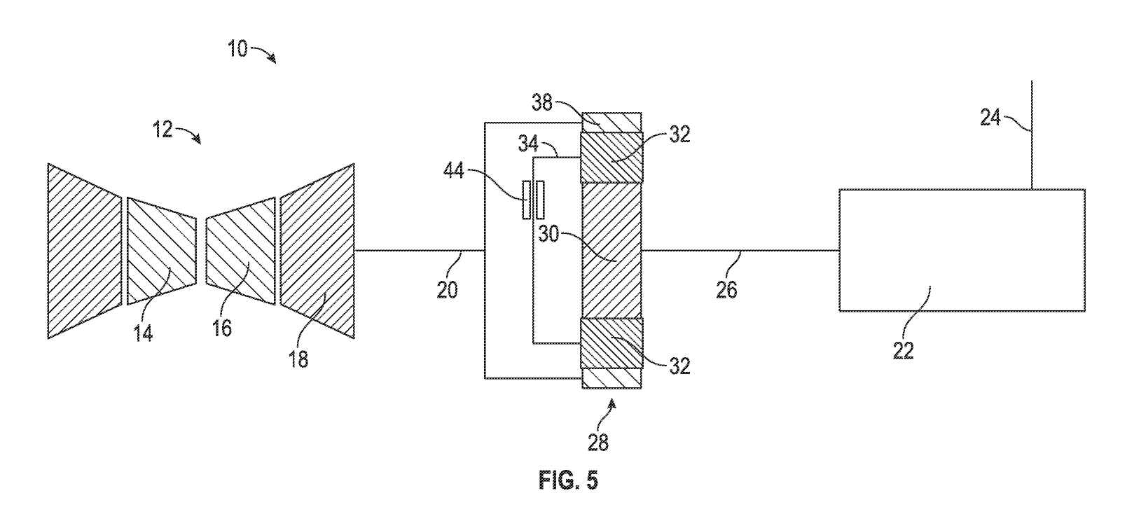

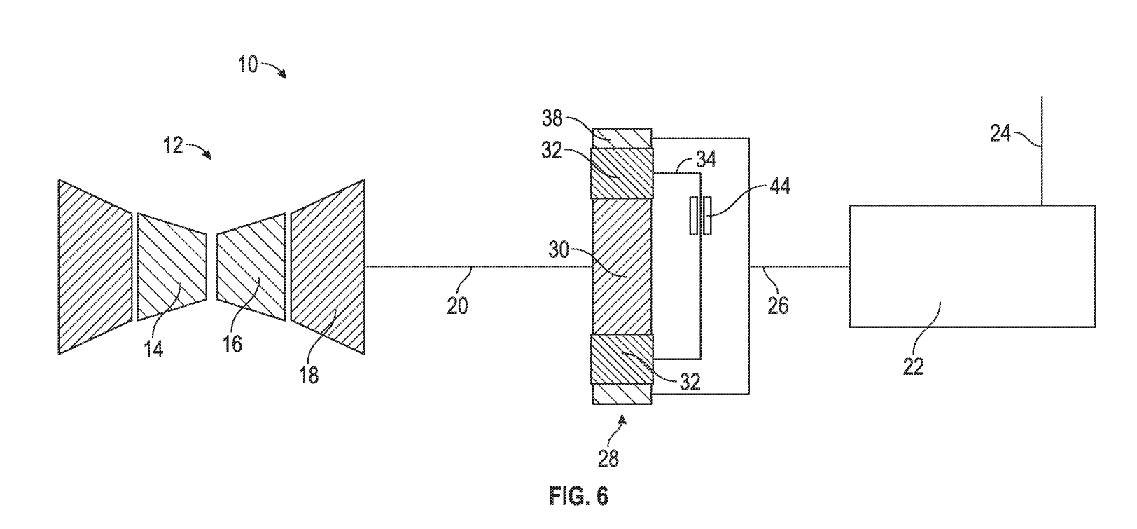

In other embodiments, the braking mechanism 44 may be located at other portions of the gear box 28. For example, in the embodiment of FIG. 5, the generator shaft 26 is connected to the sun gear 30, and the output shaft 20 is connected to the ring gear 38, while the braking mechanism 44 is located at the planet gear carrier 34 such that the braking mechanism 44 stops orbit of the planet gears 32 around the sun gear 30 when engaged with the planet gear carrier 34. Similarly, in the embodiment of FIG. 6, the braking mechanism 44 is located at the planet gear carrier 34, while the generator shaft 26 is connected to the ring gear 38 and the output shaft is connected to the sun gear 30.

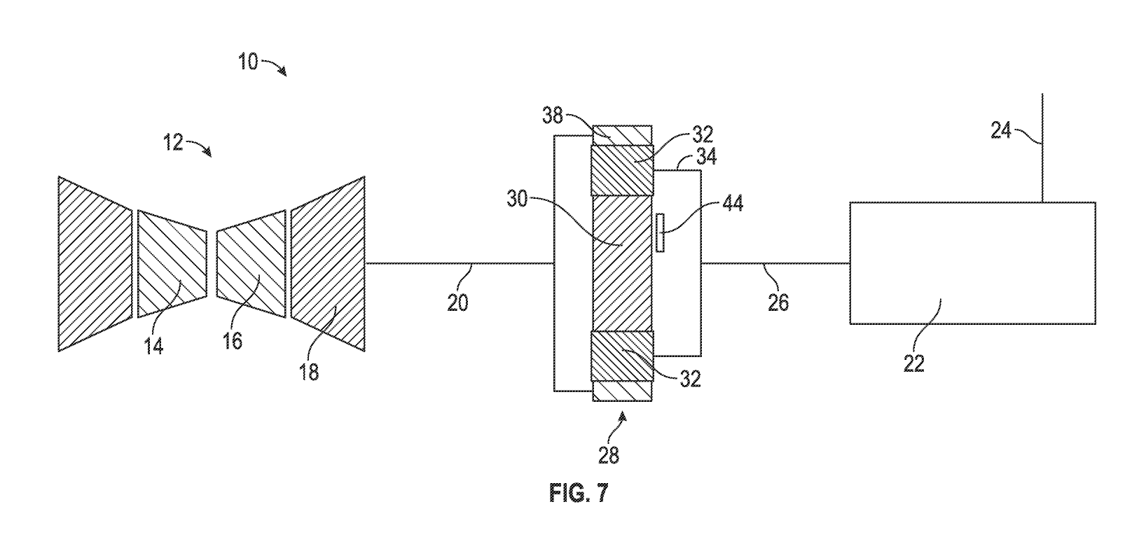

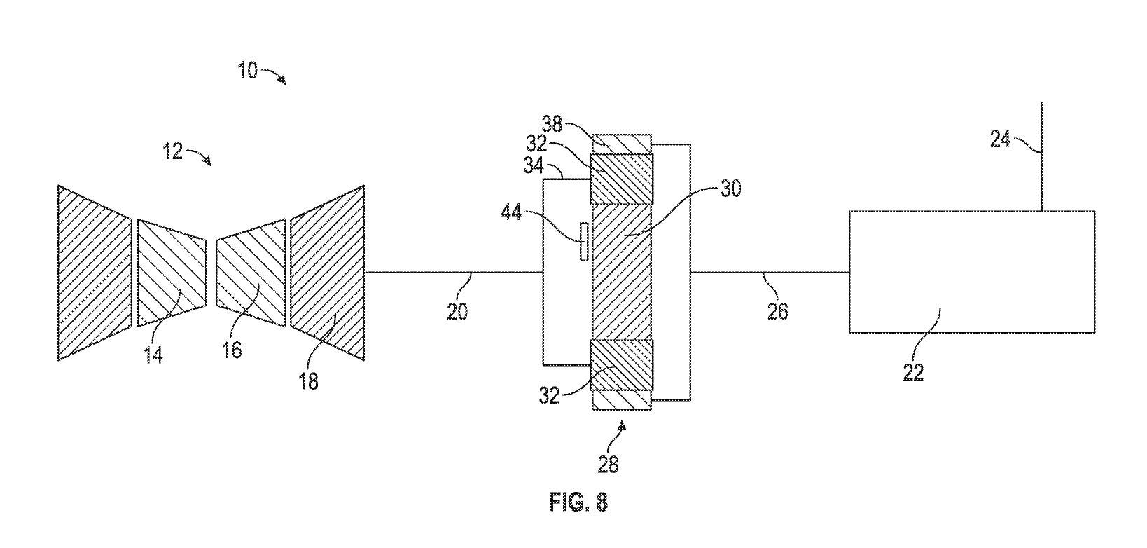

In the embodiment of FIG. 7, the braking mechanism is located at the sun gear 30, while the generator shaft 26 is connected to the planet gear carrier 34, and the output shaft 20 is connected to the ring gear 38. Alternatively, as shown in FIG. 8, the generator shaft 26 is connected to the ring gear 38, and the output shaft 20 is connected to the planet gear carrier 34.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An electrical power generation system for a vehicle comprising:
a prime mover;
an electrical generator to generate electrical power;
a gear box operably connected to the prime mover and the electrical generator to transfer rotational energy from the prime mover to the electrical generator; and
a braking mechanism at the gear box to selectably transfer rotational energy from the prime mover to the electrical generator for selective generation of electrical power.

2. The electrical power generation system of claim 1, wherein the gear box includes a planetary gear arrangement.

3. The electrical power generation system of claim 2, wherein the planetary gear arrangement includes:
a sun gear coupled to the generator;
a plurality of planet gears meshed with the sun gear and configured to traverse about a sun gear axis; and
a ring gear meshed with and disposed radially outboard of the plurality of planet gears;
wherein the prime mover is coupled to one of the plurality of planet gears or the ring gear; and
wherein the braking mechanism is disposed at the other of the plurality of planet gears or the ring gear to stop of rotation of the ring gear or traversal of the plurality of planet gears.

4. The electrical power generation system of claim 3, further comprising a planet carrier to couple the prime mover to the plurality of planet gears.

5. The electrical power generation system of claim 2, wherein the planetary gear arrangement includes:
a sun gear coupled to the prime mover;
a plurality of planet gears meshed with the sun gear and configured to traverse about a sun gear axis; and
a ring gear meshed with and disposed radially outboard of the plurality of planet gears;
wherein the generator is coupled to one of the plurality of planet gears or the ring gear; and
wherein the braking mechanism is disposed at the other of the plurality of planet gears or the ring gear to stop of rotation of the ring gear or traversal of the plurality of planet gears.

6. The electrical power generation system of claim 2, wherein the planetary gear arrangement includes:
a sun gear coupled to the braking mechanism;
a plurality of planet gears meshed with the sun gear and configured to traverse about a sun gear axis, the plurality of planet gears coupled to one of the generator or the prime mover; and
a ring gear meshed with and disposed radially outboard of the plurality of planet gears, the ring gear coupled to the other of the generator or the prime mover;
wherein the braking mechanism is configured to stop rotation of the sun gear.

7. The electrical power generation system of claim 1, wherein the braking mechanism includes a locking mechanism to maintain engagement of the braking mechanism.

8. The electrical power generation system of claim 1, wherein the prime mover is a gas turbine.

9. The electrical power generation system of claim 1, wherein the vehicle is an aircraft.

10. A method of electrical power generation for a vehicle comprising:
generating rotational energy at a prime mover;
transferring the rotational energy to an electrical power generator;
generating electrical power via the rotational energy transfer to the electrical power generator; and
periodically stopping and/or starting the transfer of rotational energy from the prime mover to the electrical power generator via a braking mechanism in operable communication with the electrical power generator.

11. The method of claim 9, further comprising transferring the rotational energy from the prime mover to the electrical power generator through a planetary gear arrangement.

12. The method of claim 10, further comprising:
transferring the rotational energy from the prime mover to a plurality of planet gears;
transferring the rotational energy from the plurality of planet gears to a sun gear meshed with the plurality of planet gears; and
transferring the rotational energy from the sun gear to the electrical power generator.

13. The method claim 11, further comprising transferring the rotational energy from the plurality of planet gears to the sun gear by stopping rotation of a ring gear meshed with the plurality of planet gears via engagement of a braking mechanism at the ring gear.

14. The method of claim 12, further comprising selectably stopping the transfer of rotational energy from the plurality of planet gears to the sun gear by disengagement of the braking mechanism.

15. The method of claim 12, wherein the braking mechanism includes a locking mechanism to maintain engagement of the braking mechanism.

16. The method of claim 9, wherein the prime mover is a gas turbine.

17. The method of claim 9, wherein the vehicle is an aircraft.
